(19) United States
(12) Patent Application Publication
(10) Pub. No.: US 2016/0183348 A1
(43) Pub. Date: Jun. 23, 2016

(54) ELECTRONIC BALLAST HAVING A BI-FUNCTIONAL CONTROL INPUT AND A METHOD FOR OPERATING AT LEAST ONE LIGHTING MEANS

(71) Applicant: OSRAM GmbH, Munich (DE)

(72) Inventor: Juergen Klier, Traunreut (DE)

(21) Appl. No.: 14/778,103

(22) PCT Filed: Dec. 5, 2013
(86) PCT No.: PCT/EP2013/075707

§ 371 Date: Sep. 18, 2015

(30) Foreign Application Priority Data
Mar. 20, 2013 (DE) 10 2013 204 858.0

(51) Int. Cl. H05B 37/02; H05B 37/03

(52) U.S. Cl. CPC H05B 37/0209; H05B 37/03

(57) ABSTRACT

An electronic ballast for operating an illuminant includes a control input for coupling to a control device designed to act as a current sink in a continuous control operation. The electronic ballast is designed to supply, in the continuous control operation, a current to the control device such that a DC voltage is generated at the control input within a predetermined value range. The electronic ballast is also designed to control a driver circuit for the at least one illuminant such that a power correlated to the DC voltage at the control input, in the continuous control operation, is supplied at the output of said electronic ballast. The electronic ballast is designed to switch at least the driver circuit on or off when in a switching operation and when a voltage pulse applied across the control input lies outside of the predefinable value range in the continuous control operation.

### RELATED APPLICATIONS

The present application is a national stage entry according to 35 U.S.C. §371 of PCT application No.: PCT/EP2013/075707 filed on Dec. 5, 2013, which claims priority from German application No.: 10 2013 204 858.0 filed on Mar. 20, 2013, and is incorporated herein by reference in its entirety.

### TECHNICAL FIELD

Various embodiments relate to an electronic ballast (EB) for operating at least one illuminant including a control input having a first and a second input terminal for coupling to a control device which is designed to work in a continuous control mode as a current sink, wherein the electronic ballast is designed to provide in the continuous control mode a current to the control device, so that at the control input a DC voltage in a settable value range is generated, and an output for coupling the at least one illuminant, wherein the electronic ballast is designed to control a driver circuit for the at least one illuminant such that a power is provided at the output of the electronic ballast that is correlated with the DC voltage applied at the control input in continuous control mode. Various embodiments also relate to a corresponding method for operating at least one illuminant.

### BACKGROUND

FIG. 1 in this connection shows in a schematic representation a 1-10 V-interface known in prior art, which goes back to the norm EN60929, which describes the function of the control input. The known 1-10 V-interface is thereby arranged at the input of an electronic ballast 10. For clarity reasons, only the input region of the electronic ballast 10 is shown which is of importance with regard to the present disclosure. The subsequent structure of the electronic ballast 10 is sufficiently known to the person skilled in the art.

At hand, a control device 12 is coupled to the input E1, E2 of the electronic ballast 10. The control device 12 includes, for example, a simple potentiometer 16 and works in a continuous control mode as a current sink. In the continuous control mode, the electronic ballast 10 provides a current Iₑ to the control device 12 so that a DC voltage Uₑ is generated in a settable value range at the control input E1, E2. The voltage Uₑ amounts in the continuous control mode between 1 and 10 V. The control input E1, E2 is galvanically separated from the inner circuit of the electronic ballast 10, being on the mains potential, by means of a transformer Tr. As mentioned above, the control device 12 acts as a sink, while the control input E1, E2 of the electronic ballast 10 acts as the source. In this way, for example, the already mentioned simple potentiometer 16 can be used for lighting control.

An oscillator 14 supplies the EB-inner coil L2 of the transformer Tr with a current-limited AC voltage via an ohmic resistance Rl. This is transmitted to the EB-outer coil L1 of the transformer Tr. The voltages U1, U2 are respectively peak value-rectified, for which purpose are used, on the one hand, the diode D1 and the capacitor C1, and, on the other hand, the diode D2 and the capacitor C2.

An increase of the variable load 16 of the control device 12 at the control input E1, E2 leads to a reduction of the voltage Uₑ and, thus, also of the voltage U1 on the outer transformer coil L1. This reduced peak value U1 is reproduced at the inner coil U2 and, thus, forms a variable set point Uₛ for the controlling of the power of the illuminant. The electronic ballast also has a non-illustrated output for connecting the at least one illuminant. The electronic ballast is designed to control a not shown EB internal driver circuit for the at least one illuminant such that a power is provided at the output of the electronic ballast, which is correlated to the DC voltage Uₑ applied in a continuous control mode at the control input E1, E2.

The problem with the arrangement shown in FIG. 1 is the fact that the electronic ballast 10 cannot be switched by this. A solution, in which a settable voltage is used, for example 0 V, at the input E1, E2 to switch-off the electronic ballast, is although conceivable, but, then, the electronic ballast could not be switched on again. The reason is that in the off state of the electronic ballast 10 the oscillator 14 is not operating and, therefore, the transformer Tr may not transmit control signal. The interface for a lighting control illustrated in FIG. 1 therefore permits only the adjustment of the brightness of the illuminant. Even if the brightness of the illuminant is maximally reduced (“zero light”), the electronic ballast remains in operation. This undesirably consumes energy which leads to a deterioration in the efficiency of the arrangement.

### SUMMARY

The present disclosure is based on the finding that an improvement in efficiency can be obtained when the electronic ballast is developed such that a switching function, that is switching on and off of the electronic ballast is made possible via the control input. According to the present disclosure, therefore, the electronic ballast is furthermore designed to switch on or off at least the driver circuit for the at least one illuminant in a switching mode when applying a voltage pulse to the control input which is outside the settable value range in the continuous control mode. Since the corresponding voltage pulse is outside the settable value range in a continuous control mode, undesired switchings can be avoided during normal mode. Since the at least one illuminant controlling driver circuit can be switched off, the main reason for the power consumption of the electronic ballast is eliminated. This leads to a significant increase in efficiency.

The control input of the electronic ballast may be a current sink in the switching mode, that is the control input coupled to the control device functions as a source.

The electronic ballast is designed to switch off the driver circuit at a positive or negative amplitude of the voltage pulse which is outside of the settable value range. Conversely, the electronic ballast may be designed, to switch on the driver circuit at a negative or positive amplitude of the voltage pulse which is outside of the settable value range. Thus, the serving signals during switching on and switching off of an electronic ballast are clearly separated from the signals that control the mode of the illuminant in continuous mode. Disturbances of the continuous mode are therefore excluded.

The driver circuit includes a control input, wherein the electronic ballast is designed to provide a power set value at the control input of the driver circuit, which is correlated to the DC voltage applied in continuous operating at the control input of the electronic ballast. In this way, brightness can be controlled particularly simple via the control input.

The control input of the electronic ballast may include a first and a second input terminal, wherein the electronic ballast further includes a first capacitor coupled between the first and the second input terminals of the control input of the electronic ballast, a second capacitor coupled between the control input of the driver circuit and a reference potential, a transformer having a primary winding and a secondary winding, wherein a series circuit having a first diode and the primary winding is/are coupled in parallel to the first capacitor, wherein the secondary winding is coupled between a first node and the reference potential, wherein a second diode is coupled between the first node and the control input of the driver circuit, an oscillator which is coupled to the first node, and at least one first opto-coupler having a photodiode and a phototransistor, wherein the photodiode is coupled between the second and the first input terminals of the control input, wherein the photodiode is oriented such that a current flow is enabled through the photodiode from the second input terminal to the first input terminal during application of a negative voltage pulse at the control input. By these features, on the one hand, the peak value-rectification of the voltages is realized on both windings of the transformer and, on the other hand, a negative voltage pulse at the control input is transmitted potential-free through the opto-coupler from its photodiode side to its phototransistors side. The advantage in the use of a negative voltage pulse is that a flash of light is reliably avoided during the switching mode in this way. If, however, a high positive voltage pulse is selected as a switching signal, the illuminant may possibly react quickly enough and emit an undesirable flash of light.

The electronic ballast may further include a third diode that is coupled in series to the photodiode of the first opto-coupler between the second and the first input terminals of the control input of the electronic ballast, wherein the third diode is oriented such that a current flow is enabled from the second input terminal to the first input terminal during application of a negative voltage pulse at the control input of the electronic ballast. By this diode, the input of the opto-coupler is protected against excessive reverse voltages. An ohmic resistance, optionally provided and arranged in series to the third diode, may be provided for current limiting.

It may further be provided that the driver circuit includes an ON/OFF input for switching on and off the driver circuit, which is coupled at least to the phototransistor of the first opto-coupler. In this way, it is particularly easy to use the signal transmitted to the phototransistor side of the opto-coupler for switching on and off the driver circuit. An electronic ballast suitable in this context having such a design is known for example from WO 2010/081570 A1, cf. in particular FIG. 2. Accordingly, one of the two EOL (end of life) inputs of the control circuit of the electronic ballast is driven by means of the signal transmitted to the secondary side of the opto-coupler to switch on and off the driver circuit.

The electronic ballast may include a supply voltage terminal for providing a supply voltage, wherein the phototransistor of the first opto-coupler is coupled to the ON/OFF input, wherein the phototransistor is coupled to a holding device, which in turn is coupled to the supply voltage terminal and is designed to be switched conductive by the phototransistor when it is conductive and to remain conductive as long as a settable supply voltage is applied to the supply voltage terminal. In this way, it is ensured that the holding function is terminated if there is no supply voltage present at the supply voltage terminal. This is the case when the electronic ballast is switched off, in particular the driver circuit from which the supply voltage is preferably derived.

The electronic ballast can be designed in this context to accept a lamp error, if the potential at the ON/OFF input is outside a settable value range, wherein the lower limit of this value range is 0.5 V. By the switch-off pulse, as mentioned, the voltage at the ON/OFF input is reduced to below 0.5 V and, with respect to the mentioned WO 2010/081570 A1, hence, the error “hard rectifying” is simulated. The control circuit of the electronic ballast thereon increases the operating frequency in order to remediate this error. Since this is naturally not successful (since the cause of the signal at the ON/OFF input is the switching off pulse at the control input), the control circuit merges after a certain time, for example 300 ms, into the so-called “Shut Down”. This leads to that at least the driver circuit is disabled and, thereby, that the provision of the power supply voltage is disabled at the supply voltage terminal.

The electronic ballast is further designed to monitor the potential at the ON/OFF input even with deactivated driver device. Following a potential at the ON/OFF input outside the settable value range occurring after deactivation, at least the driver circuit and, thus, the providing of the supply voltage at the supply voltage terminal are activated again. In other words, the control circuit interprets a voltage of 0.5 V at the ON/OFF input as relamping (changing lamps) in shut down mode, and then returns to normal mode. As a result, the electronic ballast may be switched on again by a respective pulse at the control input.

In the mentioned WO 2010/081570 A1, voltage dividers are available each including a lamp filament and providing voltage to the appropriate EOL input during normal mode. It is detected if the voltage decreases at the respective EOL input to 0 V during the replacement of the lamp and the electronic ballast is restarted after installing a new lamp. More specifically, in FIG. 2 of the aforementioned WO 2010//081570 A1, the EOL1 input is coupled to a voltage divider which includes the ohmic resistance R21, the filament of the lamp 1 and the ohmic resistances R22 and R23. The EOL2 input is coupled to a voltage divider that includes the ohmic resistances R31 and R31. Thus, the supply voltage terminal presently represents the tap of the respective voltage divider. If a lamp error is detected, the electronic ballast will switch-off after a certain time. Since the voltage at the respective EOL input must be in a settable value range, so that the electronic ballast operates, a lamp error is detected when the respective voltage is located outside of this settable value range. A voltage of 0 V is in any case, and thus, outside of the settable value range. Therefore, the electronic ballast switches off at occurrence of a 0 V-signal at the EOL input within 300 ms. Thus, the electronic ballast is set back to normal mode by the replacing of the lamp and, then, can be switched on again.

The holding device is designed to perform a thyristor function. Thus, a single voltage pulse transmitted via the opto-coupler is sufficient to activate the holding device.

For this purpose, the holding device may include a first and a second electronic switch, each having a control electrode, a working electrode and a reference electrode, wherein the first and second electronic switches are constructed complementarily, wherein the reference electrode of the first electronic switch is coupled to the reference potential, wherein the working electrode of the first electronic switch is coupled to the control electrode of the second electronic switch, wherein the control electrode of the first electronic switch is coupled to the working electrode of the second electronic switch, wherein the control electrode and the reference electrode of the second electronic switch are coupled to the supply voltage terminal.

The phototransistor of the first opto-coupler may be coupled between the coupling point of the working electrode of the first electronic switch and the control electrode of the second electronic switch, and the reference potential.

The coupling point is coupled to the ON/OFF input via a fourth diode. This diode prevents repercussions of the holding device for the ON/OFF input during normal mode. Without this means, the supply voltage at the supply voltage terminal could disturb the evaluation at the ON/OFF input.

A principle-related disadvantage of the previously mentioned, so-called one-button-control, in which the same control signal is used to switch on and off, is that a transmission error may result in asynchronous behavior in the controlling of several electronic ballasts by a single control device: This occurs when, for example, only a portion of the electronic ballast is switched on upon a switching signal. A repeated switching signal switches off these electronic ballasts, but switches on the remaining ones. The lighting system must be synchronized by a power interruption. The use of different signals for switching on and switching off remedies: In this context, the electronic ballast includes a second opto-coupler, wherein the photodiode of the second opto-coupler is coupled between the first and the second input terminals of the control input of the electronic ballast, wherein the photodiode is oriented such that a current flow is enabled through the photo diode of the second opto-coupler from the first to the second input terminal during application of a positive voltage pulse at the control input of the electronic ballast. In this way, a first switching mode may be triggered by a negative voltage pulse and a second switching mode may be triggered by a positive voltage pulse. The mentioned disadvantage of one-button-control can thus be reliably avoided. Of course, positive and negative voltage pulse for switching on and off may also be interchanged.

The electronic ballast may further include a zener diode which is reverse-serially coupled to the photodiode of the second opto-coupler. This prevents that a control voltage below a settable threshold value is erroneously interpreted as a switching on-signal.

The phototransistor of the first opto-coupler is coupled between the reference electrode and the working electrode of the second electronic switch. The phototransistor of the second opto-coupler, however, is coupled preferably between the ON/OFF input and the reference potential. In this way, both, the switch on and the switch off signal, may be applied to the ON/OFF input.

The electronic ballast is thus designed to implement the signals at the ON/OFF input to switch on and off the electronic ballast.

The potential is applied at the ON/OFF input for activating at least the driver circuit and the providing of the supply voltage at the supply voltage terminal below the lower limit of the settable value range, and, in particular, corresponds to the potential of assuming a lamp error. Alternatively, it is above the upper limit of the settable value range.

The presented embodiments with respect to the inventive electronic ballast and their advantages apply accordingly, where applicable, to the inventive method for operating at least one illuminant at an electronic ballast.

### BRIEF DESCRIPTION OF THE DRAWING (S)

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 in schematic representation the input region of a known from the prior art electronic ballast having a 1-10-V interface at the control input;

FIG. 2 in schematic representation of the input region of a first embodiment of an inventive electronic ballast; and

FIG. 3 in a schematic representation of the input region of a second embodiment of an inventive electronic ballast.

### DETAILED DESCRIPTION

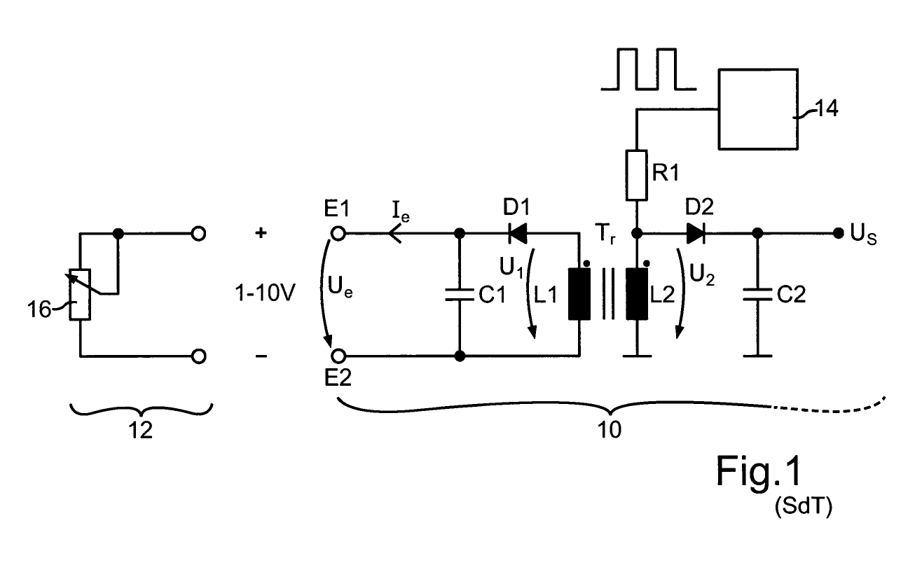

In the following, the same reference numerals are used for identical and functionally identical components. In particular, reference numerals introduced with reference to FIG. 1 are used furthermore.

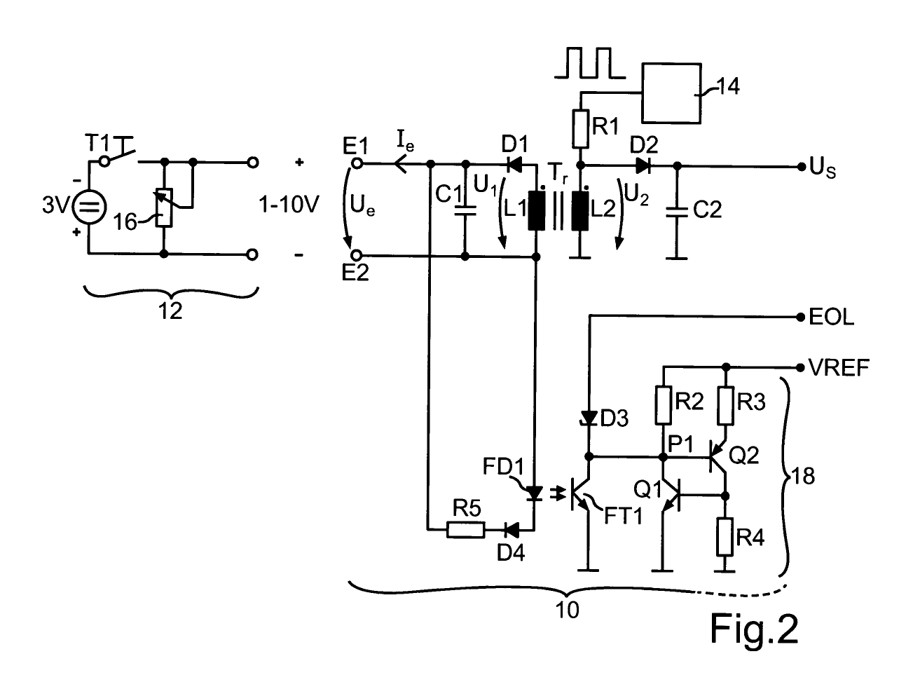

In schematic representation, FIG. 2 shows a first embodiment of an input region of an inventive electronic ballast. For clarity reasons, only the parts of the electronic ballast are shown that are important in view of the present disclosure. Examples of how the not shown components of the electronic ballast may be realized may be taken, for example, from WO 2010/081570 A1, its disclosure is fully incorporated in this regard in the present application.

The input region of an electronic ballast 10 and the control device 12 shown in detail in FIG. 2 essentially correspond to the illustrations of FIG. 1 so that in particular the differences are considered in the following. In addition to the input terminal Uₛ for setting a set point value for the power consumed in the illuminant, further, the electronic ballast 10 includes a terminal EOL and a terminal VREF. The EOL input of the control circuit of the electronic ballast 10 is usually used to detect an “end of life” of the illuminant and then to switch off the driver circuit, which serves to drive the illuminant. Thus, the voltage at the EOL input must be within a settable value range, so that the driver circuit remains activated. It is detected as an error if it is outside of this settable value range and the driver circuit is shut down. If the voltage at the supply voltage terminal VREF is reduced to 0 V, such as during relamping (changing lamps), after switching off the driver circuit, a subsequent potential at the EOL input outside of the settable value range is interpreted as a start signal after an occurred relamping and then the driver circuit is re-activated. This logic is utilized in the present disclosure.

The control device 12 switches a −3 V-signal to the control input E1, E2 of the electronic ballast 10 upon actuation of the switch T1. Then, the opto-coupler U1 that includes on the primary side a photodiode FD1 and on the secondary side a phototransistor FT1 switches conductive the phototransistor FT1. As a result, a holding device 18 which includes the ohmic resistances R2, R3, R4 and the transistors Q1 and Q2 are also switched conductive, provided that the holding device 18 is supplied with voltage via the supply voltage terminal VREF.

The transistors Q1 and Q2 together form a thyristor-auxiliary-circuit that holds conductive both transistors as long as the supply voltage is applied at the supply voltage terminal VREF after one of the transistors Q1, Q2 has been switched conductive. Therefore, with activated holding function, the potential at the point P1 is equal to the mass potential, whereby the potential at the EOL input of the control circuit is decreased below 0.5 V. The control circuit interprets this as “hard rectifying”, i.e. the lamp is gradually coming to an end of service life. To compensate for this error, the control circuit now increases the operating frequency with which the switches of the bridge circuit are driven to eliminate this error. Since the cause is different in the present case, this of course does not succeed. Then, the control circuit after a certain time, for example 300 ms, merges into the shut down mode. As a result, the driver circuit is switched off. Since the supply voltage terminal VREF is obtained from the load circuit, which is also switched off after switching off the driver circuit, VREF falls down to 0 V whereby the holding device 18 is reset.

In shut-down mode, the control circuit interprets an input voltage at the EOL input of less than 0.5 V as relamping and returns to normal mode. This is the case after switching off of VREF, so that the electronic ballast can be switched on again by re-pressing the button T1.

The point P1 is at 0 V via the transistor Q1 as long as VREF is present. That is, a further −3 V-pulse by the control device 12 results in a signal of 0 V at the EOL input again. Since this is again below the settable threshold, the driver circuit switches on again. The diode D4 protects the input of the opto-coupler U1 against high reverse voltages, the ohmic resistor R limits the current through the opto-coupler U1. The Schottky diode D3 prevents repercussions of the thyristor-auxiliary-circuit 18 on the EOL input during normal mode. It prevents, in particular, disturbances on EOL input from VREF at the point P1.

The proposed control method is compatible to devices which operate with the 1-10 V-interface described in EN60929. Control devices having a switching function may control electronic ballasts without switching function, and vice versa. The switching function is of course only available when all electronic ballasts coupled to the control device 12 are equipped with it.

It could be considered disadvantageous that a lighting system that has been switched off via the control input may be switched on unintentionally by a power failure. This problem may be solved by designing the electronic ballasts so that they initially switch into shut-down mode upon applying the mains voltage and only start after a switching signal at the control input E1, E2. However, this would mean a renunciation from the 1-10 V-standard.

The embodiment shown in FIG. 2 relates to a so-called one-button-control, in which the same control signal is used to switch on and switch off. However, when controlling several electronic ballasts coupled in parallel to the control input E1, E2, a transmission error may cause asynchronous behavior: If only a part of the electronic ballasts are switched on, for example, by a switching signal at the control input E1, E2, a repeated switching signal may cause these electronic ballasts to switch off again while the others are switched on. The lighting system must be synchronized, for example, by a power interruption. However, in the embodiment shown in FIG. 2 a long press on the button T1 is sufficient to cause a synchronization since all connected electronic ballasts are switched off at a press on the button T1 that lasts long enough: Devices that are “on” assume to recognize an error and thus switch off. Devices that are switched off assume that just a relamping has occurred and therefore are also available to restart after the completion of the press on the button T1.

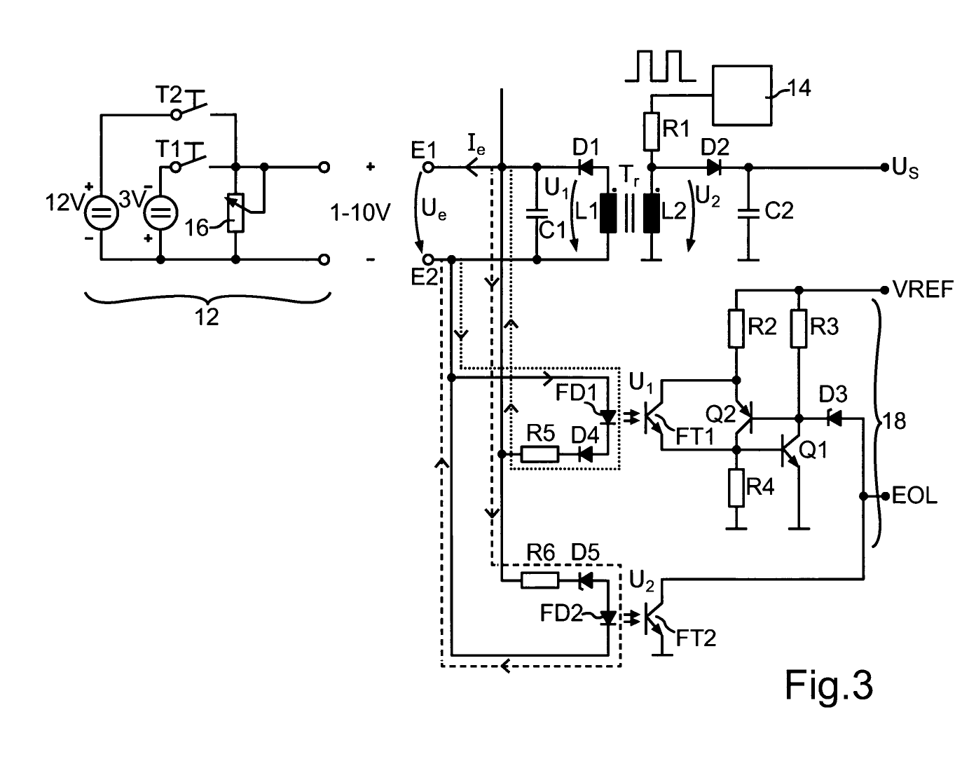

Alternatively, different signals may be provided for the use of switching on and switching off, as this enabled in the embodiment shown in FIG. 3.

Here, besides the −3 V signal by means of the button T1 for switching off, the control device 12 provides also a +12 V-signal by means of the button T2 to switch on the electronic ballasts coupled to the control device 12. The negative switch-off signal now no longer acts directly on the EOL input via the opto-coupler U1, but now controls the transistor Q1 of the thyristor-auxiliary-circuit 18 which then cause the switching off (see also the dotted drawn current path on the primary side of the opto-coupler U1).

The positive switching on signal, see the dashed current path, acts directly on the EOL input via the second opto-coupler U2, which includes a second photodiode FD2 and a second phototransistor FT2, but cannot control the thyristor-auxiliary-circuit 18. The zener diode D5 prevents that a control voltage below +12 V is interpreted as a switching on signal by the opto-coupler U2.

After a first-time switching off of the electronic ballasts 10 coupled to the control device 12 by applying a −3 V-pulse by means of the button T1, a second pressing of the button T1 does not lead to a switching on because VREF is not present. Only the applying of a +12 V pulse by means of button T2 causes that the potential at the EOL input is pulled down on a potential that the assumption of a relamping is justified so that electronic ballast is switched on again.

While in the present embodiments it has been resort to functions of the control circuit, such as carried out in regard to the WO 2010/081570 A1, the present disclosure can of course also be realized otherwise, for example, by evaluating the switching signal of the one or more opto-coupler(s) directly from the control circuit of the electronic ballasts and implementing the corresponding switching mode. For example, the control circuit may be formed therefore to check the voltage on the secondary side of the opto-coupler to see if they will change in a predefined way. If this is the case, the driver circuit is switched off. A further settable change may lead to that the driver circuit is re-activated again.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An Electronic ballast for operating at least one illuminant comprising:
a control input having a first and a second input terminal for coupling to a control device which is designed in a continuous control mode to function as a current sink;
wherein the electronic ballast is designed to provide a control current to the control device in the continuous mode, so that a direct voltage is generated in a settable value range at the control input; and
an output for connecting the at least one illuminant;
wherein the electronic ballast is designed to drive a driver circuit for the at least one illuminant such that a power is provided at the output of the electronic ballast which is correlated to the DC voltage applied at the control input in a continuous control mode;
wherein
the electronic ballast is further designed to switch on or off at least the driver circuit in a switching mode when applying a voltage pulse to the control input, which is outside the settable value range in a continuous.

2. The electronic ballast according to claim 1,
wherein
the control input of the electronic ballast is a current sink in the switching mode.

3. The electronic ballast according to claim 1,
wherein
the electronic ballast is designed to switch off the driver circuit at a positive or negative amplitude of the voltage pulse which is outside of the settable value range.

4. The electronic ballast according to claim 1,
wherein
the electronic ballast is designed to switch on the driver circuit at a positive or negative amplitude of the voltage pulse which is outside of the settable value range.

5. The electronic ballast according to claim 1,
wherein
the driver circuit comprises a control input, wherein the electronic ballast is designed to provide a power setpoint value at the control input of the driver circuit, that is correlated to the DC voltage applied at the control input of the electronic ballasts in the continuous mode.

6. The electronic ballast according to claim 5,
wherein
the control input of the electronic ballast comprises a first and a second input terminal, wherein the electronic ballast further comprises:
a first capacitor which is coupled between the first and the second input terminal of the control input of the electronic ballast;
a second capacitor which is coupled between the control input of the driver circuit and a reference potential;
a transformer having a primary winding and a secondary winding, wherein a series circuit comprising a first diode and the primary winding are coupled in parallel to the first capacitor, wherein the secondary winding is coupled between a first node and the reference potential, wherein a second diode is coupled between the first node and the control input of the driver circuit and;
an oscillator coupled to the first node; and
at least one first opto-coupler having a photodiode and a phototransistor, wherein the photodiode is coupled between the second and the first input terminals of the control input, wherein the photodiode is oriented such that a current flow through the photodiode from the second input terminal to the first input terminal is enabled during application of a negative voltage pulse to the control input.

7. The electronic ballast according to claim 6,
wherein
the electronic ballast further comprises a third diode which is serially connected to the photodiode of the first opto-coupler between the second and the first input terminals of the control input of the electronic ballast, wherein the third diode is oriented such that a current flow is enabled from the second input terminal to the first input terminal during application of a negative voltage pulse to the control input of the electronic ballast.

8. The electronic ballast according to claim 6,
wherein
the driver circuit comprises an ON/OFF input, which is coupled at least with the phototransistor of the first opto-coupler, for switching on and off of the driver circuit.

9. The electronic ballast according to claim 8,
wherein
the electronic ballast comprises a supply voltage terminal for providing a supply voltage,
wherein the phototransistor of the first opto-coupler is coupled to the ON/OFF input, whereby the phototransistor is coupled with a holding device which in turn is coupled to the supply voltage terminal and is designed to be switched conductive by the phototransistor if it is conductive and to remain conductive as long as a settable supply voltage is applied at the supply voltage terminal.

10. The electronic ballast according to claim 9,
wherein
the holding device is designed to perform a thyristor function.

11. The electronic ballast according to claim 10,
wherein
the holding device comprises a first and a second electronic switch, each comprising a control electrode, a working electrode and a reference electrode, wherein the first and the second electronic switches are complementary constructed, wherein the reference electrode of the first electronic switch is coupled to the reference potential, wherein the working electrode of the first electronic switch is coupled to the control electrode of the second electronic switch, wherein the control electrode of the first electronic switch is coupled to the working electrode of the second electronic switch, wherein the control electrode and the reference electrode of the second electronic switch are coupled to the supply voltage terminal.

12. The electronic ballast according to claim 11,
wherein
the phototransistor of the first opto-coupler is coupled between the coupling point of the working electrode of the first electronic switch and the control electrode of the second electronic switch and the reference potential.

13. The electronic ballast according to claim 12,
wherein
the coupling point is coupled with the ON/OFF input via a fourth diode.

14. The electronic ballast according to claim 7,
wherein
the electronic ballast further comprises a second opto-coupler, wherein the photodiode of the second opto-coupler is coupled between the first and the second input terminals of the control input of the electronic ballast, wherein the photodiode is oriented such that a current flow is enabled through the photodiode of the second opto-coupler from the first to the second input terminal during application of a positive voltage pulse to the control input of the electronic ballast.

15. The electronic ballast according to claim 14,
wherein
the electronic ballast further comprises a zener diode, which is coupled in revers serial to the photodiode of the second opto-coupler.

16. The electronic ballast according to claim 14,
wherein
the phototransistor of the first opto-coupler is coupled between the reference electrode and the working electrode of the second electronic switch.

17. (canceled)

18. The electronic ballast according to claim 8,
wherein
the electronic ballast is designed to implement the signals at the ON/OFF input for switching on and off of the electronic ballast.

19. The electronic ballast according to claim 18,
wherein
the electronic ballast is designed:
to assume a lamp error, when the potential at the ON/OFF input is outside a settable value range, wherein the lower limit of this value range is 0.5 V,
when assuming a lamp error, to deactivate at least the driver circuit and the providing of the supply voltage at the supply voltage terminal,
to monitor the potential at the ON/OFF input even at deactivated driver device; and
to re-enable at least the driver circuit and the providing of the supply voltage at the supply voltage terminal when a potential outside of the settable value range occurs at the ON/OFF INPUT follows after deactivation.

20. The electronic ballast according to claim 19,
wherein
the potential is below the lower limit of the settable value range at the ON/OFF input for activating of at least the driver circuit and the providing of the supply voltage at the supply voltage terminal, or
above the upper limit of the settable value range.

21. A method for operating at least one illuminant at an electronic ballast comprising a control input having a first and a second input terminal for coupling to a control device which is designed to act as a current sink in a continuous control mode, wherein the electronic ballast is designed to provide a current to the control device in the continuous control mode, so that a DC voltage is generated in a settable value range at the control input, and an output for coupling the at least one illuminant, wherein the electronic ballast is designed to drive a driver circuit for the at least one illuminant such that a power is provided at the output of the electronic ballast that is correlated to the DC voltage applied at the control input in a continuous control mode,
the method comprising:
switching on or off at least the driver circuit in a switching mode when applying a voltage pulse to the control input, which is outside the settable value range in the continuous mode control.
